(19) United States
(12) Patent Application Publication
(10) Pub. No.: US 2015/0170812 A1
(43) Pub. Date: Jun. 18, 2015

(54) MANUFACTURING METHOD OF GRAIN-ORIENTED ELECTRICAL STEEL SHEET

(71) Applicants: Kenichi Murakami, Tokyo (JP); Yoshiyuki Ushigami, Tokyo (JP); Fumiaki Takahashi, Tokyo (JP)

(72) Inventors: Kenichi Murakami, Tokyo (JP); Yoshiyuki Ushigami, Tokyo (JP); Fumiaki Takahashi, Tokyo (JP)

(73) Assignee: NIPPON STEEL & SUMITOMO METAL CORPORATION, Tokyo (JP)

(21) Appl. No.: 14/414,845

(22) PCT Filed: Jul. 20, 2012
(86) PCT No.: PCT/JP2012/068483

§ 371 Date: Jan. 14, 2015

(51) Int. Cl. H01F 1/147; C21D 9/46; C22C 38/02; C22C 38/06; C22C 38/00; C22C 38/04; C22C 38/60; C22C 38/34; C22C 38/20; C22C 38/32; C22C 38/16; C22C 38/24; C22C 38/08; C22C 38/12; C22C 38/40; C22C 38/22; C23C 8/26; C21D 8/12

(52) U.S. Cl. CPC H01F 1/14775; C21D 8/1261; C21D 8/1255; C21D 8/1222; C21D 8/1233; C21D 9/46; C22C 38/02; C22C 38/06; C22C 38/001; C22C 38/04; C22C 38/008; C22C 38/60; C22C 38/002; C22C 38/34; C22C 38/20; C22C 38/32; C22C 38/16; C22C 38/24; C22C 38/08; C22C 38/12; C22C 38/40; C22C 38/22; C23C 8/26

(57) ABSTRACT

A slab having a desired composition containing Sn: 0.02% to 0.20% and P: 0.010% to 0.080% is used. A finishing temperature of hot rolling is 950° C. or lower, hot-rolled sheet annealing is performed at 800° C. to 1200° C., a cooling rate from 750° C. to 300° C. in the hot-rolled sheet annealing is 10° C./second to 300° C./second, and a reduction ratio of cold rolling is 85% or more. A nitridation treatment in which an N content of a decarburization-annealed steel sheet is increased is performed between beginning of decarburization annealing and occurrence of secondary recrystallization in finish annealing.

### TECHNICAL FIELD

The present invention relates to a manufacturing method of a grain-oriented electrical steel sheet suitable for an iron core of a transformer (trans.) or the like.

### BACKGROUND ART

A grain-oriented electrical steel sheet is a steel sheet which contains Si and in which crystal grains are highly integrated in a {110}<001> orientation (Goss orientation), and is used as a material of an iron core of a stationary induction device such as a transformer or the like. The control of the orientation of crystal grains is conducted with catastrophic grain growth phenomenon called secondary recrystallization.

As a method of controlling the secondary recrystallization, the following two methods can be cited. In one method, a slab is heated at a temperature of 1300° C. or higher to solid-dissolve fine precipitates called inhibitors almost completely, and thereafter, is subjected to hot-rolling, cold-rolling, annealing, and so on, to cause fine precipitates to precipitate during the hot-rolling and the annealing. In the other method, a slab is heated at a temperature of lower than 1300° C., and thereafter, is subjected to hot-rolling, cold-rolling, decarburization annealing, a nitridation treatment, finish annealing, and so on, to cause AlN, (Al, Si)N, and so on to precipitate as an inhibitor during the nitridation treatment. The former method is sometimes called high-temperature slab heating, and the latter method is sometimes called low-temperature slab heating or intermediate-temperature slab heating.

Further, a material of iron core strongly requires a low core loss property in order to decrease loss to be caused during energy conversion. A core loss of a grain-oriented electrical steel sheet is classified into a hysteresis loss and an eddy current loss roughly. The hysteresis loss is affected by a crystal orientation, a defect, a grain boundary, and so on. The eddy current loss is affected by a thickness, an electrical resistance value, a 180-degree magnetic domain width, and so on.

Then, in recent years, in order to decrease the core loss drastically, there has been proposed a technique in which in order to drastically decrease the eddy current loss, which occupies most of the core loss, a groove and/or a strain are/is artificially introduced into the surface of a grain-oriented electrical steel sheet and further a 180-degree magnetic domain is subdivided. However, for the artificial introduction of a groove and/or a strain, man hours and cost for it are needed.

Further, there also has been proposed a technique regarding adjustment of annealing conditions and the like, but it has been difficult to sufficiently improve the core loss so far.

### CITATION LIST

### Patent Literature

Patent Literature 1: Japanese Laid-open Patent Publication No. 9-104922

Patent Literature 2: Japanese Laid-open Patent Publication No. 9-104923

Patent Literature 3: Japanese Examined Patent Application Publication No. 6-51887

### SUMMARY OF INVENTION

### Technical Problem

The present invention has an object to provide a manufacturing method of a grain-oriented electrical steel sheet allowing core loss to be improved effectively.

### Solution to Problem

The present inventors, as a result of repeated earnest examinations with the aim of solving the above-described problems, found that by forming a large number of nuclei of grains in the Goss orientation before occurrence of secondary recrystallization, the number of grains in the Goss orientation after the secondary recrystallization can be increased, and by such an increase in the number of grains in the Goss orientation, core loss can be improved and further variations in core loss can also be decreased. Further, the present inventors also found that for the formation of nuclei, adjusting ranges of a Sn content and a P content in particular and conditions of hot-rolled sheet annealing is effective.

The present invention has been made based on the above-described knowledge, and the gist thereof is as follows.

(1)

A manufacturing method of a grain-oriented electrical steel sheet includes:

performing hot rolling of a slab containing, in mass %, C: 0.025% to 0.075%, Si: 2.5% to 4.0%, Mn: 0.03% to 0.30%, acid-soluble Al: 0.010% to 0.060%, N: 0.0010% to 0.0130%, Sn: 0.02% to 0.20%, S: 0.0010% to 0.020%, and P: 0.010% to 0.080%, and a balance being composed of Fe and inevitable impurities to obtain a hot-rolled steel sheet;

performing hot-rolled sheet annealing of the hot-rolled steel sheet to obtain an annealed steel sheet;

performing cold rolling of the annealed steel sheet to obtain a cold-rolled steel sheet;

performing decarburization annealing of the cold-rolled steel sheet to obtain a decarburization-annealed steel sheet in which primary recrystallization has been caused;

finish annealing the decarburization-annealed steel sheet to make secondary recrystallization occur; and

further performing a nitridation treatment in which an N content of the decarburization-annealed steel sheet is increased, between beginning of the decarburization annealing and occurrence of the secondary recrystallization in the finish annealing, wherein

a finishing temperature in the hot rolling is 950° C. or lower,

the hot-rolled sheet annealing is performed at 800° C. to 1200° C.,

a cooling rate from 750° C. to 300° C. in the hot-rolled sheet annealing is 10° C./second to 300° C./second, and

a reduction ratio in the cold rolling is 85% or more.

(2)

The manufacturing method of the grain-oriented electrical steel sheet according to (1), wherein the reduction ratio in the cold rolling is 88% or more.

(3)

The manufacturing method of the grain-oriented electrical steel sheet according to (1) or (2), wherein the reduction ratio in the cold rolling is 92% or less.

(4)

The manufacturing method of the grain-oriented electrical steel sheet according to any one of (1) to (3), wherein at least one pass in the cold rolling is performed at 200° C. to 300° C.

(5)

The manufacturing method of the grain-oriented electrical steel sheet according to any one of (1) to (4), wherein an increasing temperature rate in the decarburization annealing is 30° C./second or more.

(6)

The manufacturing method of the grain-oriented electrical steel sheet according to any one of (1) to (5), wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

### Advantageous Effects of Invention

According to the present invention, composition of a slab, conditions of hot-rolled sheet annealing and so on are made appropriate, and thereby it is possible to improve core loss effectively without performing control of magnetic domains and so on.

### BRIEF DESCRIPTION OF DRAWINGS

FIG. 1 is a flowchart illustrating a manufacturing method of a grain-oriented electrical steel sheet according to an embodiment of the present invention.

### DESCRIPTION OF EMBODIMENTS

As described above, present inventors found that the formation of a large number of nuclei of grains in the Goss orientation before occurrence of secondary recrystallization contributes to improvement of core loss and a decrease in variations in core loss, and that, for the formation of nuclei, adjusting ranges of a Sn content and a P content in particular and conditions of hot-rolled sheet annealing are effective.

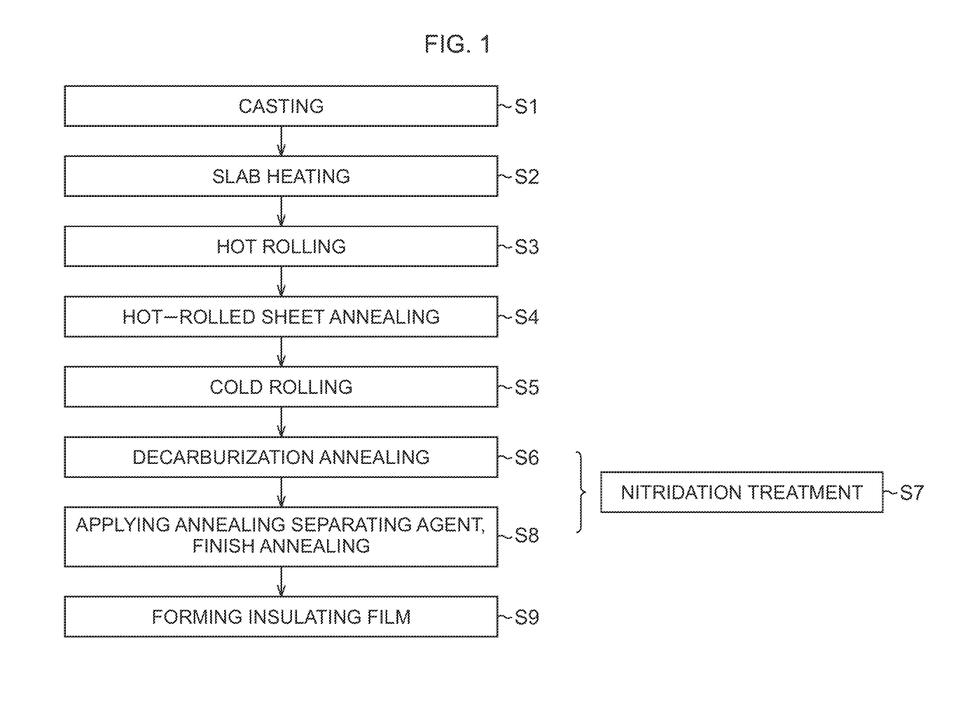

Hereinafter, there will be explained an embodiment of the present invention made based on these pieces of knowledge. FIG. 1 is a flowchart illustrating a manufacturing method of a grain-oriented electrical steel sheet according to the embodiment of the present invention. Hereinafter, % being the unit of the content of each component means mass %.

In the present embodiment, first, casting of a molten steel for a grain-oriented electrical steel sheet having a predetermined composition is performed to make a slab (Step S1). A method of casting is not limited in particular. The molten steel contains, for example, C: 0.025% to 0.075%, Si: 2.5% to 4.0%, Mn: 0.03% to 0.30%, acid-soluble Al: 0.010% to 0.060%, N: 0.0010% to 0.0130%, Sn: 0.02% to 0.20%, S: 0.0010% to 0.020%, and P: 0.010% to 0.080%. The balance of the molten steel is remaining Fe and inevitable impurities. Incidentally, elements that form inhibitors in processes of manufacturing the grain-oriented electrical steel sheet and remain in the grain-oriented electrical steel sheet after purification by high-temperature annealing are also included in the inevitable impurities.

Here, there will be explained reasons for limiting the numerical values of the composition of the above-described molten steel.

C is an element effective for controlling a structure obtained through primary recrystallization (primary recrystallization structure). When the C content is less than 0.025%, this effect cannot be obtained sufficiently. On the other hand, when the C content exceeds 0.075%, time required for decarburization annealing is long, which results in increasing an amount of CO₂ emissions. Incidentally, unless the decarburization annealing is performed sufficiently, a grain-oriented electrical steel sheet having a good magnetic property is not easily obtained. Thus, the C content is set to 0.025% to 0.075%.

Si is an element quite effective for increasing electrical resistance of a grain-oriented electrical steel sheet to thereby decrease an eddy current loss constituting a part of a core loss. When the Si content is less than 2.5%, it is not possible to sufficiently suppress the eddy current loss. On the other hand, when the Si content exceeds 4.0%, cold working is difficult to be performed. Thus, the Si content is set to 2.5% to 4.0%.

Mn increases specific resistance of a grain-oriented electrical steel sheet to decrease a core loss. Mn also exhibits a function of preventing occurrence of crack during hot rolling. When the Mn content is less than 0.03%, these effects cannot be obtained sufficiently. On the other hand, when the Mn content exceeds 0.30%, a magnetic flux density of a grain-oriented electrical steel sheet decreases. Thus, the Mn content is set to 0.03% to 0.30%.

Acid-soluble Al is an important element which forms AlN functioning as an inhibitor. When the content of acid-soluble Al is less than 0.010%, it is not possible to form a sufficient amount of AlN and thus inhibitor strength is insufficient. On the other hand, when the content of acid-soluble Al exceeds 0.060%, AlN coarsens, and thereby the inhibitor strength decreases. Thus, the content of acid-soluble Al is set to 0.010% to 0.060%.

N is an important element that reacts with acid-soluble Al to thereby form AlN. As will be described later, a nitridation treatment is performed after cold rolling, so that a large amount of N is not required to be contained in a steel for a grain-oriented electrical steel sheet, but when the N content is set to be less than 0.0010%, there is sometimes a case that a large load is required during manufacturing a steel. On the other hand, when the N content exceeds 0.0130%, a hole called blister is caused in a steel sheet during cold rolling. Thus, the N content is set to 0.0010% to 0.0130%.

Sn contributes to the formation of nuclei of grains in the Goss orientation. Though details of the reason are unclear, it is inferably because by the addition of Sn, a slip system of Fe changes and a deformation style in deformation by rolling differs from the case of no Sn being added. Further, Sn improves the quality of an oxide layer formed during decarburization annealing, and also improves the quality of a glass film formed using the oxide layer during finish annealing. That is, Sn improves the magnetic property and suppresses variations in magnetic property, through the stabilization of formation of the oxide layer and the glass film. When the Sn content is less than 0.02%, these effects cannot be obtained sufficiently. On the other hand, when the Sn content exceeds 0.20%, there is sometimes a case that a surface of a steel sheet is difficult to be oxidized and thus the formation of a glass film is insufficient. Thus, the Sn content is set to 0.02% to 0.20%.

S is an important element that reacts with Mn to thereby form MnS precipitates. The MnS precipitates mainly affect the primary recrystallization to exhibit a function of suppressing locational variation in grain growth of the primary recrystallization due to the hot rolling. When the S content is less than 0.0010%, this effect cannot be obtained sufficiently. On the other hand, when the S content exceeds 0.020%, the magnetic property is likely to deteriorate. Thus, the S content is set to 0.0010% to 0.020%.

P increases the specific resistance of a grain-oriented electrical steel sheet to decrease a core loss. Further, P contributes to the formation of nuclei of grains in the Goss orientation. Though details of this reason are unclear, similarly to Sn, it is inferably because by the addition of P, a slip system of Fe changes and a deformation style in deformation by rolling differs from the case of no P being added. When the P content is less than 0.010%, these effects cannot be obtained sufficiently. On the other hand, when the P content exceeds 0.080%, the cold rolling sometimes is difficult to be performed. Thus, the P content is set to 0.010% to 0.080%.

Note that at least one of the following various elements may also be contained in the molten steel.

Cr improves the quality of an oxide layer formed during decarburization annealing, and also improves the quality of a glass film formed using the oxide layer during finish annealing. That is, Cr improves the magnetic property and suppresses variations in magnetic property, through the stabilization of formation of the oxide layer and the glass film. However, when the Cr content exceeds 0.20%, there is sometimes a case that the formation of a glass film is unstable. Thus, the Cr content is preferably 0.20% or less. Further, in order to sufficiently obtain the above-described effects, the Cr content is preferably 0.002% or more.

Further, the molten steel may also contain at least one selected from the group consisting of Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%. Each of these elements is an inhibitor strengthening element.

In the present embodiment, after the slab is made from the molten steel having such a composition, the slab is heated (Step S2). The temperature of the heating is preferably set to 1250° C. or lower from the viewpoint of energy saving.

Then, the hot rolling of the slab is performed to thereby obtain a hot-rolled steel sheet (Step S3). In the present embodiment, a finishing temperature of the hot rolling is set to 950° C. or lower. When the finishing temperature is higher than 950° C., a texture deteriorates in the subsequent processes and particularly the nuclei of grains in the Goss orientation, which are formed during decarburization annealing, are decreased. Incidentally, the thickness of a hot-rolled steel sheet is not limited in particular, and is set to 1.8 mm to 3.5 mm, for example.

Thereafter, hot-rolled sheet annealing of the hot-rolled steel sheet is performed to thereby obtain an annealed steel sheet (Step S4). In the present embodiment, the hot-rolled sheet annealing is performed at 800° C. to 1200° C. When the temperature of the hot-rolled sheet annealing is lower than 800° C., recrystallization of the hot-rolled steel sheet (hot-rolled sheet) is insufficient and a texture after the cold rolling and the subsequent decarburization annealing deteriorates to thereby make it difficult to obtain a grain-oriented electrical steel sheet provided with a sufficient magnetic property. On the other hand, when the temperature of the hot-rolled sheet annealing is higher than 1200° C., brittle deterioration of the hot-rolled steel sheet (hot-rolled sheet) is significant to increase a possibility that fracture is caused in the subsequent cold rolling. Further, in the present embodiment, in cooling from 800° C. to 1200° C., a cooling rate from 750° C. to 300° C. is set to 10° C./second to 300° C./second. When the cooling rate in the temperature range is less than 10° C./second, a texture after the cold rolling and the subsequent decarburization annealing deteriorates to thereby make it difficult to obtain a grain-oriented electrical steel sheet provided with a sufficient magnetic property. On the other hand, when the cooling rate in the temperature range is greater than 300° C./second, a cooling facility is likely to be overloaded. Incidentally, the cooling rate in the temperature range is preferably set to 20° C./second or more.

Subsequently, the cold rolling of the annealed steel sheet is performed to thereby obtain a cold-rolled steel sheet (Step S5). The cold rolling may be performed only one time, or may also be performed a plurality of times while intermediate annealing being performed therebetween. The intermediate annealing is preferably performed at a temperature of 750° C. to 1200° C. for 30 seconds to 10 minutes, for example.

Incidentally, when the cold rolling is performed without the intermediate annealing as described above being performed, there is sometimes a case that a uniform property is not easily obtained. Meanwhile, when the cold rolling is performed a plurality of times while the intermediate annealing being performed therebetween, a uniform property is easily obtained, but the magnetic flux density sometimes decreases. Thus, the number of times of the cold rolling and whether or not the intermediate annealing is performed are preferably determined according to the property and cost required for a grain-oriented electrical steel sheet to be obtained finally.

Further, even in any case, a reduction ratio in the cold rolling is set to 85% or more. When the reduction ratio is less than 85%, grains in orientations deviated from the Goss orientation are generated in the subsequent secondary recrystallization. Further, in order to obtain a better property, the reduction ratio is preferably set to 88% or more. Further, the reduction ratio is preferably set to 92% or less. When the reduction ratio is greater than 92%, similarly to the case of being less than 85%, grains deviated from the Goss orientation are generated in the subsequent secondary recrystallization.

After the cold rolling, the decarburization annealing is performed on the cold-rolled steel sheet in a moist atmosphere containing hydrogen and nitrogen, to thereby obtain a decarburization-annealed steel sheet (Step S6). Carbon in the steel sheet is removed by the decarburization annealing, and the primary recrystallization occurs. The temperature of the decarburization annealing is not limited in particular, but when the temperature of the decarburization annealing is lower than 800° C., grains obtained by the primary recrystallization (primary recrystallization grains) may be too small, and thus there is sometimes a case that the subsequent secondary recrystallization does not sufficiently occur. On the other hand, when the temperature of the decarburization annealing exceeds 950° C., the primary recrystallization grains may be too large, and thus there is sometimes a case that the subsequent secondary recrystallization does not sufficiently occur.

Thereafter, an annealing separating agent containing MgO as its main component in a water slurry form is applied on the surface of the decarburization-annealed steel sheet, and the decarburization-annealed steel sheet is coiled. Then, batch-type finish annealing is performed on the coiled decarburization-annealed steel sheet to thereby obtain a coiled finish-annealed steel sheet (Step S8). The secondary recrystallization occurs through the finish annealing.

Further, the nitridation treatment is performed between beginning of the decarburization annealing and occurrence of the secondary recrystallization in the finish annealing (Step S7). This is to form inhibitors of (Al, Si)N. The above nitridation treatment may be performed during the decarburization annealing (Step S6), or may also be performed during the finish annealing (Step S8). In the case when it is performed during the decarburization annealing, the annealing may be performed in an atmosphere containing a gas having nitriding capability such as ammonia, for example. Meanwhild, the nitridation treatment may be performed at a heating zone or a soaking zone in a continuous annealing furnace, or the nitridation treatment may also be performed at a stage after the soaking zone. In the case when the nitridation treatment is performed during the finish annealing, a powder having nitriding capability such as MnN, for example, may be added to the annealing separating agent.

Then, after the finish annealing, the coiled finish-annealed steel sheet is uncoiled, and the annealing separating agent is removed. Subsequently, a coating solution containing aluminum phosphate and colloidal silica as its main component is applied on the surface of the finish-annealed steel sheet and is baked to form an insulating film (Step S9).

The grain-oriented electrical steel sheet can be manufactured as described above.

It should be noted that the above-described embodiment merely illustrates a concrete example of implementing the present invention, and the technical scope of the present invention is not to be construed in a restrictive manner by the embodiment. That is, the present invention may be implemented in various forms without departing from the technical spirit or main features thereof.

### EXAMPLE

Next, experiments conducted by the present inventors will be explained. Conditions and so on in these experiments are examples employed for confirming the applicability and effects of the present invention, and the present invention is not limited to these examples.

(Experiment 1)

In Experiment 1, first, in a vacuum melting furnace, 13 types of steel ingots were made each containing, in mass %, Si: 3.2%, C: 0.05%, Mn: 0.1%, Al: 0.03%, N: 0.01%, S: 0.01%, Cu: 0.02%, Ni: 0.02%, and As: 0.001%, and further containing Sn and P at various content. The balance of each of the steel ingots was Fe and inevitable impurities. The Sn content and the P content of each of the steel ingots are listed in Table 1. Then, on each of the steel ingots, annealing was performed at 1150° C. for one hour and thereafter hot rolling was performed, to thereby obtain hot-rolled steel sheets (hot-rolled sheets) each having a thickness of 2.3 mm. A finishing temperature of the hot rolling was set to 940° C.

Subsequently, annealing was performed on each of the hot-rolled sheets at 1100° C. for 120 seconds, and thereafter the hot-rolled sheets were each soaked in a hot water bath to be cooled at a cooling rate of 35° C./s from 750° C. to 300° C. Then, pickling was performed, and thereafter cold rolling was performed to thereby obtain cold-rolled steel sheets (cold-rolled sheets) each having a thickness of 0.23 mm. In the cold rolling, the rolling was performed by about 30 passes, and at two passes out of them, the hot-rolled sheets were each heated to 250° C. to be subjected to the rolling immediately. Subsequently, on each of the cold-rolled sheets, decarburization annealing was performed at 860° C. for 100 seconds in a gas atmosphere containing water vapor, hydrogen, and nitrogen, and subsequently nitridation annealing was performed at 770° C. for 20 seconds in a gas atmosphere containing hydrogen, nitrogen, and ammonia. An increasing temperature rate in the decarburization annealing was set to 32° C./s. Then, an annealing separating agent containing MgO as its main component in a water slurry form was applied, and then finish annealing was performed at 1200° C. for 20 hours.

Finish-annealed steel sheets were each water washed, and of each of the steel sheets, a single-sheet for magnetic measurement having a size of W60×L300 mm was cut out. Then, application and baking of a coating film solution containing aluminum phosphate and colloidal silica as its main component were performed. Thus, grain-oriented electrical steel sheets each having an insulating film attached thereto were manufactured.

Then, annealing of each of the manufactured grain-oriented electrical steel sheets was performed at 750° C. for two hours to thereby remove a strain (for example, a shear strain) caused when cutting out. Thereafter, a core loss W17/50 was measured. At that time, under each of 13 types of conditions, the measurement of the core loss W17/50 was performed on the five single-sheets and an average value (average W17/50) and a difference between a maximum value and a minimum value (ΔW17/50) of measurement results were calculated. This result is listed in Table 1. Incidentally, the core loss W17/50 is the value of core loss obtained when the magnetic flux density of 1.7 T is applied at 50 Hz. Further, the difference between the maximum value and the minimum value is the index indicating variations in the core loss W17/50.

TABLE 1

| | | | AVERAGE | | |
|---|---|---|---|---|---|
| SYMBOL | | | W17/50 | Δ W17/50 | |
| No. | Sn(%) | P(%) | (W/kg) | (W/kg) | REMARK |
| 1-1 | 0.004 | 0.007 | 0.876 | 0.264 | COMPARATIVE |
| | | | | | EXAMPLE |
| 1-2 | 0.005 | 0.028 | 0.867 | 0.223 | COMPARATIVE |
| | | | | | EXAMPLE |
| 1-3 | 0.02 | 0.027 | 0.848 | 0.162 | EXAMPLE |
| 1-4 | 0.06 | 0.026 | 0.821 | 0.091 | EXAMPLE |
| 1-5 | 0.12 | 0.028 | 0.825 | 0.084 | EXAMPLE |
| 1-6 | 0.19 | 0.026 | 0.838 | 0.073 | EXAMPLE |
| 1-7 | 0.22 | 0.027 | 0.862 | 0.061 | COMPARATIVE |
| | | | | | EXAMPLE |
| 1-8 | 0.04 | 0.007 | 0.863 | 0.224 | COMPARATIVE |
| | | | | | EXAMPLE |
| 1-9 | 0.04 | 0.011 | 0.849 | 0.164 | EXAMPLE |
| 1-10 | 0.04 | 0.024 | 0.822 | 0.093 | EXAMPLE |
| 1-11 | 0.05 | 0.047 | 0.826 | 0.081 | EXAMPLE |
| 1-12 | 0.05 | 0.078 | 0.839 | 0.072 | EXAMPLE |

| | | | | |
|---|---|---|---|---|
| 1-13 | 0.04 | 0.085 | IMPOSSIBLE TO | COMPARATIVE |
| | | | MEASURE MAGNETIC | EXAMPLE |
| | | | CHARACTERISTICS | |

As listed in Table 1, in symbols No. 1-3 to No. 1-6 and No. 1-9 to No. 1-12 each having the Sn content of 0.02% to 0.20% and the P content of 0.010% to 0.080%, the average W17/50 was 0.85 W/kg or less, which was small, and ΔW17/50 was also 0.2 W/kg or less, which was small. That is, in the symbols No. 1-3 to No. 1-6 and No. 1-9 to No. 1-12, it was possible to obtain the good magnetic property. In the symbols No. 1-4, No. 1-5, No. 1-10, and No. 1-11, which were particularly good among them, the Sn content was 0.04% to 0.12% and the P content was 0.020% to 0.050%. Incidentally, in a symbol No. 1-13, fracture was caused in the cold rolling, and thus it was not possible to manufacture a grain-oriented electrical steel sheet.

(Experiment 2)

In Experiment 2, first, in a vacuum melting furnace, steel ingots were made each containing, in mass %, Si: 3.2%, C: 0.06%, Mn: 0.1%, Al: 0.03%, N: 0.01%, S: 0.01%, Sn: 0.04%, P: 0.03%, Sb: 0.02%, Cr: 0.09%, and Pb: 0.001%. The balance of each of the steel ingots was Fe and inevitable impurities. Then, on each of the steel ingots, annealing was performed at 1180° C. for one hour and thereafter hot rolling was performed, to thereby obtain hot-rolled steel sheets (hot-rolled sheets) each having a thickness of 2.3 mm. Between the annealing and the hot rolling, waiting was performed for various time periods, and a finishing temperature (FT) of the hot rolling was varied between 880° C. and 970° C. The finishing temperature (FT) is listed in Table 2.

Subsequently, hot-rolled sheet annealing was performed on each of the hot-rolled sheets at an annealing temperature (HA) between 780° C. and 1210° C. for 110 seconds, and then the hot-rolled sheets were each cooled. At that time, a cooling method was changed and a cooling rate (CR) from 750° C. to 300° C. was varied between 5° C./s and 295° C./s. As the cooling method, there can be cited air cooling, hot-water cooling using water at 100° C., hot-water cooling using water at 80° C., hot-water cooling using water at 70° C., hot-water cooling using water at 60° C., hot-water cooling using water at 40° C., water cooling (20° C.) using water at 20° C., and ice salt-water cooling using ice salt water. The annealing temperature (HA) and the cooling rate (CR) of each of the hot-rolled sheets are listed in Table 2. Thereafter, cold rolling was performed to thereby obtain cold-rolled steel sheets (cold-rolled sheets) each having a thickness of 0.23 mm. In the cold rolling, the rolling was performed by about 30 passes, and at two passes out of them, the hot-rolled sheets were each heated to 250° C. to be subjected to the rolling immediately. Subsequently, on each of the cold-rolled sheets, decarburization annealing was performed at 850° C. for 90 seconds in a gas atmosphere containing water vapor, hydrogen, and nitrogen, and subsequently nitridation annealing was performed at 750° C. for 20 seconds in a gas atmosphere containing hydrogen, nitrogen, and ammonia. An increasing temperature rate in the decarburization annealing was set to 33° C./s. Then, an annealing separating agent containing MgO as its main component in a water slurry form was applied, and then finish annealing was performed at 1200° C. for 20 hours.

Finish-annealed steel sheets were each water washed, and of each of the steel sheets, a single-sheet for magnetic measurement having a size of W60×L300 mm was cut out. Then, application and baking of a coating film solution containing aluminum phosphate and colloidal silica as its main component were performed. Thus, grain-oriented electrical steel sheets each having an insulating film attached thereto were manufactured.

Then, by a method similar to that in Experiment 1, a value of the “average W17/50” and a value of “Δ17/50” were obtained. This result is listed in Table 2.

TABLE 2

| SYM- | | | | AVERAGE | Δ | |
|---|---|---|---|---|---|---|
| BOL | FT | HA | CR | W17/50 | W17/50 | |
| No. | (° C.) | (° C.) | (° C./s) | (W/kg) | (W/kg) | REMARK |
| 2-1 | 880 | 1050 | 25 | 0.821 | 0.071 | EXAMPLE |
| 2-2 | 920 | 1050 | 25 | 0.828 | 0.093 | EXAMPLE |
| 2-3 | 940 | 1050 | 25 | 0.834 | 0.139 | EXAMPLE |
| 2-4 | 970 | 1050 | 25 | 0.853 | 0.224 | COMPAR- |
| | | | | | | ATIVE |
| | | | | | | EXAMPLE |
| 2-5 | 930 | 780 | 45 | 0.872 | 0.258 | COMPAR- |
| | | | | | | ATIVE |
| | | | | | | EXAMPLE |
| 2-6 | 930 | 810 | 45 | 0.847 | 0.188 | EXAMPLE |
| 2-7 | 930 | 910 | 45 | 0.843 | 0.173 | EXAMPLE |
| 2-8 | 930 | 1010 | 45 | 0.838 | 0.158 | EXAMPLE |
| 2-9 | 930 | 1110 | 45 | 0.822 | 0.093 | EXAMPLE |
| 2-10 | 930 | 1210 | 45 | IMPOSSIBLE TO | | COMPAR- |
| | | | | MEASURE MAGNETIC | | ATIVE |
| | | | | CHARACTERISTICS | | EXAMPLE |
| 2-11 | 930 | 1100 | 5 | 0.864 | 0.254 | COMPAR- |
| | | | | | | ATIVE |
| | | | | | | EXAMPLE |
| 2-12 | 930 | 1100 | 13 | 0.828 | 0.164 | EXAMPLE |
| 2-13 | 930 | 1100 | 29 | 0.821 | 0.092 | EXAMPLE |
| 2-14 | 930 | 1100 | 95 | 0.839 | 0.081 | EXAMPLE |
| 2-15 | 930 | 1100 | 196 | 0.842 | 0.072 | EXAMPLE |
| 2-16 | 930 | 1100 | 295 | 0.848 | 0.063 | EXAMPLE |

As listed in Table 2, in symbols No. 2-1 to No. 2-3, No. 2-6 to No. 2-9, and No. 2-12 to No. 2-16 each having the finishing temperature (FT) of 950° C. or lower, the annealing temperature (HA) of 800° C. to 1200° C., and the cooling rate (CR) of 10° C./s to 300° C./s, the average W17/50 was 0.85 W/kg or less, which was small, and ΔW17/50 was also 0.2 W/kg or less, which was small. That is, in the symbols No. 2-1 to No. 2-3, No. 2-6 to No. 2-9, and No. 2-12 to No. 2-16, it was possible to obtain the good magnetic property. In the symbols No. 2-1, No. 2-2, No. 2-9, No. 2-12, and No. 2-13, which were particularly good out of them, the finishing temperature (FT) was 930° C. or lower, the annealing temperature (HA) was 1050° C. to 1200° C., and the cooling rate (CR) was 10° C./s to 50° C./s. Incidentally, in a symbol No. 2-10, the annealing temperature (HA) was 1210° C., which was high, and the brittle deterioration was severe. Then, it was not possible to manufacture a grain-oriented electrical steel sheet because fracture was caused in the cold rolling.

(Experiment 3)

In Experiment 3, first, in a vacuum melting furnace, steel ingots were made each containing, in mass %, Si: 3.1%, C: 0.04%, Mn: 0.1%, Al: 0.03%, N: 0.01%, S: 0.01%, Sn: 0.06%, P: 0.02%, Se: 0.001%, V: 0.003%, As: 0.001%, Mo: 0.002%, and Bi: 0.001%. The balance of each of the steel ingots is Fe and inevitable impurities. Then, on each of the steel ingots, annealing was performed at 1150° C. for one hour and thereafter hot rolling was performed, to thereby obtain hot-rolled steel sheets (hot-rolled sheets) having various thicknesses (HG). The thickness of each of the hot-rolled sheets (HG) is listed in Table 3. A finishing temperature of the hot rolling was set to 940° C.

Subsequently, on each of the hot-rolled sheets, annealing was performed at 1120° C. for 10 seconds and further annealing was performed at 920° C. for 100 seconds, and thereafter the hot-rolled sheets were each soaked in a hot water bath to be cooled at a cooling rate of 25° C./s from 750° C. to 300° C. Then, pickling was performed, and thereafter cold rolling was performed to thereby obtain cold-rolled steel sheets (cold-rolled sheets) each having a thickness of 0.275 mm. In the cold rolling, the rolling was performed by 30 to 40 passes, and at one pass out of them, the hot-rolled sheets were each heated to 240° C. to be subjected to the rolling immediately. As for the four steel sheets, the heating to 240° C. was omitted. Whether or not the heating was performed is listed in Table 3. Subsequently, on each of the cold-rolled sheets, decarburization annealing was performed at 850° C. for 110 seconds in a gas atmosphere containing water vapor, hydrogen, and nitrogen, and subsequently nitridation annealing was performed at 750° C. for 20 seconds in a gas atmosphere containing hydrogen, nitrogen, and ammonia. An increasing temperature rate in the decarburization annealing was set to 31° C./s. Then, an annealing separating agent containing MgO as its main component in a water slurry form was applied, and then finish annealing was performed at 1180° C. for 20 hours.

Finish-annealed steel sheets were each water washed, and of each of the steel sheets, a single-sheet for magnetic measurement having a size of W60×L300 mm was cut out. Then, application and baking of a coating film solution containing aluminum phosphate and colloidal silica as its main component were performed. Thus, grain-oriented electrical steel sheets each having an insulating film attached thereto were manufactured.

Then, by a method similar to that in Experiment 1, a value of the “average W17/50” and a value of “ΔW17/50” were obtained. This result is listed in Table 3. Incidentally, the cold-rolling ratio in Table 3 is a value obtained from the thickness of the hot-rolled sheet (HG) and the thickness of the cold-rolled sheet (0.275 mm).

TABLE 3

| | | REDUCTION | | AVERATE | | |
|---|---|---|---|---|---|---|
| SYMBOL | HG | RATIO | WITH OR WITH- | W17/50 | ΔW17/50 | |
| No. | (mm) | (%) | OUT HEATING | (W/kg) | (W/kg) | REMARK |
| 3-1 | 1.72 | 84 | WITH | 0.977 | 0.086 | COMPARATIVE |
| | | | | | | EXAPLE |
| 3-2 | 1.83 | 85 | WITH | 0.929 | 0.092 | EXAMPLE |
| 3-3 | 1.96 | 86 | WITH | 0.924 | 0.097 | EXAMPLE |
| 3-4 | 2.29 | 88 | WITH | 0.909 | 0.104 | EXAMPLE |
| 3-5 | 2.29 | 88 | WITHOUT | 0.968 | 0.203 | COMPARATIVE |
| | | | | | | EXAPLE |
| 3-6 | 2.75 | 90 | WITH | 0.888 | 0.121 | EXAMPLE |
| 3-7 | 2.75 | 90 | WITHOUT | 0.947 | 0.224 | COMPARATIVE |
| | | | | | | EXAPLE |
| 3-8 | 3.06 | 91 | WITH | 0.886 | 0.146 | EXAMPLE |
| 3-9 | 3.06 | 91 | WITHOUT | 0.945 | 0.247 | COMPARATIVE |
| | | | | | | EXAPLE |
| 3-10 | 3.44 | 92 | WITH | 0.903 | 0.188 | EXAMPLE |
| 3-11 | 3.44 | 92 | WITHOUT | 0.941 | 0.287 | COMPARATIVE |
| | | | | | | EXAPLE |
| 3-12 | 3.93 | 93 | WITH | 0.952 | 0.259 | COMPARATIVE |
| | | | | | | EXAPLE |

As listed in Table 3, in symbols No. 3-2 to No. 3-4, No. 3-6, No. 3-8, and No. 3-10 each having the cold-rolling ratio of 85% to 92% and having the heating to 240° C. performed thereon, the average W17/50 was 0.93 W/kg or less, which was small, and ΔW17/50 was also 0.2 W/kg or less, which was small. That is, in the symbols No. 3-2 to No. 3-4, No. 3-6, No. 3-8, and No. 3-10, it was possible to obtain the good magnetic property. In the symbols No. 3-4, No. 3-6, No. 3-8, and No. 3-10 each having the average W17/50 of 0.91 W/kg or less, which were particularly good among them, the cold-rolling ratio was 88% to 92% and the heating to 240° C. was performed.

(Experiment 4)

In Experiment 4, first, in a vacuum melting furnace, three types of steel ingots were made each containing, in mass %, Si: 3.1%, C: 0.07%, Mn: 0.1%, Al: 0.03%, N: 0.01%, S: 0.01%, Cu: 0.09%, and B: 0.001%, and further containing Sn and P at various content. The balance of each of the steel ingots was Fe and inevitable impurities. The Sn content and the P content of each of the steel ingots are listed in Table 4. Then, on each of the steel ingots, annealing was performed at 1150° C. for one hour and thereafter hot rolling was performed, to thereby obtain hot-rolled steel sheets (hot-rolled sheets) each having a thickness of 2.5 mm. A finishing temperature of the hot rolling was set to 930° C.

Subsequently, on each of the hot-rolled sheets, annealing was performed at 1080° C. for 110 seconds, and thereafter the hot-rolled sheets were each soaked in a hot water bath to be cooled at a cooling rate of 32° C./s from 750° C. to 300° C. Then, pickling was performed, and thereafter cold rolling was performed to thereby obtain cold-rolled steel sheets (cold-rolled sheets) each having a thickness of 0.230 mm. In the cold rolling, the rolling was performed by about 30 passes, and at one pass out of them, the hot-rolled sheets were each heated to 270° C. to be subjected to the rolling immediately. Subsequently, on each of the cold-rolled sheets, decarburization annealing was performed at 830° C. for 80 seconds in a gas atmosphere containing water vapor, hydrogen, and nitrogen, and subsequently nitridation annealing was performed at 800° C. for 30 seconds in a gas atmosphere containing hydrogen, nitrogen, and ammonia. An increasing temperature rate (HR) in the decarburization annealing was varied between 15° C./s and 300° C./s. The increasing temperature rate (HR) is listed in Table 4. Then, an annealing separating agent containing MgO as its main component in a water slurry form was applied, and then finish annealing was performed at 1190° C. for 20 hours.

Finish-annealed steel sheets were each water washed, and of each of the steel sheets, a single-sheet for magnetic measurement having a size of W60×L300 mm was cut out. Then, application and baking of a coating film solution containing aluminum phosphate and colloidal silica as its main component were performed. Thus, grain-oriented electrical steel sheets each having an insulating film attached thereto were manufactured.

Then, by a method similar to that in Experiment 1, a value of the “average W17/50” and a value of “ΔW17/50” were obtained. This result is listed in Table 4.

TABLE 4

| | | | | AVERAGE | | |
|---|---|---|---|---|---|---|
| SYMBOL | | | | W17/50 | ΔW17/50 | |
| No. | Sn | P | HR | (W/kg) | (W/Kg) | REMARK |
| 4-1 | 0.004 | 0.007 | 15 | 0.897 | 0.328 | COMPAR- |
| | | | | | | ATIVE |
| | | | | | | EXAPLE |
| 4-2 | | | 35 | 0.868 | 0.254 | COMPAR- |
| | | | | | | ATIVE |
| | | | | | | EXAPLE |
| 4-3 | | | 100 | 0.846 | 0.223 | COMPAR- |
| | | | | | | ATIVE |
| | | | | | | EXAPLE |
| 4-4 | | | 300 | 0.849 | 0.211 | COMPAR- |
| | | | | | | ATIVE |
| | | | | | | EXAPLE |
| 4-5 | 0.08 | 0.031 | 15 | 0.838 | 0.189 | EXAMPLE |
| 4-6 | | | 35 | 0.824 | 0.122 | EXAMPLE |
| 4-7 | | | 100 | 0.811 | 0.083 | EXAMPLE |
| 4-8 | | | 300 | 0.814 | 0.079 | EXAMPLE |
| 4-9 | 0.22 | 0.055 | 15 | 0.919 | 0.137 | COMPAR- |
| | | | | | | ATIVE |
| | | | | | | EXAPLE |
| 4-10 | | | 35 | 0.904 | 0.082 | COMPAR- |
| | | | | | | ATIVE |
| | | | | | | EXAPLE |
| 4-11 | | | 100 | 0.893 | 0.074 | COMPAR- |
| | | | | | | ATIVE |
| | | | | | | EXAPLE |
| 4-12 | | | 300 | 0.898 | 0.063 | COMPAR- |
| | | | | | | ATIVE |
| | | | | | | EXAPLE |

As listed in Table 4, in symbols No. 4-5 to No. 4-8 each having the Sn content of 0.02% to 0.20% and the P content of 0.010% to 0.080%, the average W17/50 was 0.85 W/kg or less, which was small, and ΔW17/50 was also 0.20 W/kg or less, which was small. That is, in the symbols No. 4-5 to No. 4-8, it was possible to obtain the good magnetic property. In the symbols No. 4-6 to No. 4-8 each having the average W17/50 of 0.83 W/kg or less and ΔW17/50 of 0.15 W/kg or less, which were particularly good among them, the increasing temperature rate (HR) was 30° C./s or more.

### INDUSTRIAL APPLICABILITY

The present invention may be utilized in an industry of manufacturing electrical steel sheets and an industry of utilizing electrical steel sheets, for example.

1-6. (canceled)

7. A manufacturing method of a grain-oriented electrical steel sheet comprising:
performing hot rolling of a slab containing, in mass %, C: 0.025% to 0.075%, Si: 2.5% to 4.0%, Mn: 0.03% to 0.30%, acid-soluble Al: 0.010% to 0.060%, N: 0.0010% to 0.0130%, Sn: 0.02% to 0.20%, S: 0.0010% to 0.020%, and P: 0.010% to 0.080%, and a balance being composed of Fe and inevitable impurities to obtain a hot-rolled steel sheet;
performing hot-rolled sheet annealing of the hot-rolled steel sheet to obtain an annealed steel sheet;
performing cold rolling of the annealed steel sheet to obtain a cold-rolled steel sheet;
performing decarburization annealing of the cold-rolled steel sheet to obtain a decarburization-annealed steel sheet in which primary recrystallization has been caused;
finish annealing the decarburization-annealed steel sheet to make secondary recrystallization occur; and
further performing a nitridation treatment in which an N content of the decarburization-annealed steel sheet is increased, between beginning of the decarburization annealing and occurrence of the secondary recrystallization in the finish annealing, in a gas atmosphere containing hydrogen, nitrogen and ammonia, wherein
a finishing temperature in the hot rolling is 950° C. or lower,
the hot-rolled sheet annealing is performed at 800° C. to 1200° C.,
a cooling rate from 750° C. to 300° C. in the hot-rolled sheet annealing is 29° C./second to 300° C./second,
a reduction ratio in the cold rolling is 85% or more, and
at least one pass in the cold rolling is performed at 200° C. to 300° C.

8. The manufacturing method of the grain-oriented electrical steel sheet according to claim 7, wherein the reduction ratio in the cold rolling is 88% or more.

9. The manufacturing method of the grain-oriented electrical steel sheet according to claim 7, wherein the reduction ratio in the cold rolling is 92% or less.

10. The manufacturing method of the grain-oriented electrical steel sheet according to claim 8, wherein the reduction ratio in the cold rolling is 92% or less.

11. The manufacturing method of the grain-oriented electrical steel sheet according to claim 7, wherein at least one pass in the cold rolling is performed at 240° C. to 270° C.

12. The manufacturing method of the grain-oriented electrical steel sheet according to claim 8, wherein at least one pass in the cold rolling is performed at 240° C. to 270° C.

13. The manufacturing method of the grain-oriented electrical steel sheet according to claim 9, wherein at least one pass in the cold rolling is performed at 240° C. to 270° C.

14. The manufacturing method of the grain-oriented electrical steel sheet according to claim 10, wherein at least one pass in the cold rolling is performed at 240° C. to 270° C.

15. The manufacturing method of the grain-oriented electrical steel sheet according to claim 7, wherein an increasing temperature rate in the decarburization annealing is 30° C./second or more.

16. The manufacturing method of the grain-oriented electrical steel sheet according to claim 8, wherein an increasing temperature rate in the decarburization annealing is 30° C./second or more.

17. The manufacturing method of the grain-oriented electrical steel sheet according to claim 9, wherein an increasing temperature rate in the decarburization annealing is 30° C./second or more.

18. The manufacturing method of the grain-oriented electrical steel sheet according to claim 10, wherein an increasing temperature rate in the decarburization annealing is 30° C./second or more.

19. The manufacturing method of the grain-oriented electrical steel sheet according to claim 11, wherein an increasing temperature rate in the decarburization annealing is 30° C./second or more.

20. The manufacturing method of the grain-oriented electrical steel sheet according to claim 12, wherein an increasing temperature rate in the decarburization annealing is 30° C./second or more.

21. The manufacturing method of the grain-oriented electrical steel sheet according to claim 13, wherein an increasing temperature rate in the decarburization annealing is 30° C./second or more.

22. The manufacturing method of the grain-oriented electrical steel sheet according to claim 14, wherein an increasing temperature rate in the decarburization annealing is 30° C./second or more.

23. The manufacturing method of the grain-oriented electrical steel sheet according to claim 7, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

24. The manufacturing method of the grain-oriented electrical steel sheet according to claim 8, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

25. The manufacturing method of the grain-oriented electrical steel sheet according to claim 9, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

26. The manufacturing method of the grain-oriented electrical steel sheet according to claim 10, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

27. The manufacturing method of the grain-oriented electrical steel sheet according to claim 11, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

28. The manufacturing method of the grain-oriented electrical steel sheet according to claim 12, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

29. The manufacturing method of the grain-oriented electrical steel sheet according to claim 13, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

30. The manufacturing method of the grain-oriented electrical steel sheet according to claim 14, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

31. The manufacturing method of the grain-oriented electrical steel sheet according to claim 15, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

32. The manufacturing method of the grain-oriented electrical steel sheet according to claim 16, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

33. The manufacturing method of the grain-oriented electrical steel sheet according to claim 17, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

34. The manufacturing method of the grain-oriented electrical steel sheet according to claim 18, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

35. The manufacturing method of the grain-oriented electrical steel sheet according to claim 19, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

36. The manufacturing method of the grain-oriented electrical steel sheet according to claim 20, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

37. The manufacturing method of the grain-oriented electrical steel sheet according to claim 21, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.

38. The manufacturing method of the grain-oriented electrical steel sheet according to claim 22, wherein the slab further contains at least one selected from the group consisting of, in mass %, Cr: 0.002% to 0.20%, Sb: 0.002% to 0.20%, Ni: 0.002% to 0.20%, Cu: 0.002% to 0.40%, Se: 0.0005% to 0.02%, Bi: 0.0005% to 0.02%, Pb: 0.0005% to 0.02%, B: 0.0005% to 0.02%, V: 0.002% to 0.02%, Mo: 0.002% to 0.02%, and As: 0.0005% to 0.02%.
